(19) United States
(12) Patent Application Publication
(10) Pub. No.: US 2019/0393709 A1
(43) Pub. Date: Dec. 26, 2019

(54) MOBILE POWER AND CHARGING STATION

(71) Applicant: MOORECO, INC., TEMPLE, TX (US)

(72) Inventors: RYAN HAASE, TEMPLE, TX (US); GREG MOORE, TEMPLE, TX (US); ROLLAND LOW, TEMPLE, TX (US); SCOTT DARLEY, TEMPLE, TX (US)

(73) Assignee: MOORECO, INC., TEMPLE, TX (US)

(21) Appl. No.: 16/453,254

(22) Filed: Jun. 26, 2019

Related U.S. Application Data
(60) Provisional application No. 62/690,062, filed on Jun. 26, 2018.

(51) Int. Cl. H02J 7/02; H02J 7/00

(52) U.S. Cl. CPC H02J 7/022; H02J 7/0029; H02J 7/0068; H02J 7/0047; H02J 7/0042

(57) ABSTRACT

The mobile power and charging station is a multiple outlet power and charging station with at least one on-board rechargeable battery for providing a transportable power supply for powering and charging mobile devices and the like. The mobile power and charging station includes a housing having an upper portion, a central portion and a base portion. A plurality of wheels are mounted on the base portion of the housing, allowing the housing to be transported to any desired location. A plurality of electrical outlets are mounted to the upper portion of the housing and are in electrical communication with a surge suppressor. At least one rechargeable battery is removably received within an internal compartment of the housing. The at least one rechargeable battery is in electrical communication with the surge suppressor and the plurality of electrical outlets.

### CROSS-REFERENCE TO RELATED APPLICATION

This application claims the benefit of U.S. Provisional Patent Application No. 62/690,062, filed on Jun. 26, 2018.

### BACKGROUND

### 1. FIELD

The disclosure of the present patent application relates to electrical power supplies, and particularly to a multiple outlet power and charging station with at least one on-board rechargeable battery for providing a transportable power supply for powering and charging mobile devices and the like.

### 2. DESCRIPTION OF THE RELATED ART

As is well known in the art, power strips, charging hubs and the like are fed, typically, from only a single electrical outlet. Thus, although such equipment may provide multiple electrical outlets for powering and charging, for example, a number of smartphones, laptop computers and the like, the equipment being charged and/or powered must be positioned directly adjacent the power strip, charging hub or the like, and this power source is tethered to a single location by its own connection to the electrical outlet. Further, although power strips, charging hubs and the like are often provided with surge protectors, to prevent damage to connected electrical loads in the event of a power surge, the equipment is still vulnerable to interruptions in power. In other words, conventional power strips, charging hubs and the like cease to function if the external power supply to which they are connected has an interruption or cessation of power. Given the great utility of conventional power strips, charging hubs and the like, it would obviously be desirable to be able to provide such functionality with an additional uninterruptable power supply. It would be further desirable to be able to provide such power and charging capability in a mobile and transportable manner. Thus, a mobile power and charging station solving the aforementioned problems is desired.

### SUMMARY

The mobile power and charging station is a multiple outlet power and charging station with at least one on-board rechargeable battery for providing a transportable power supply for powering and charging mobile devices and the like. The mobile power and charging station includes a housing having an upper portion, a central portion and a base portion. The housing has an internal compartment defined therein. A door may be provided for releasably covering the internal compartment. A plurality of wheels are mounted on the base portion of the housing, allowing the housing to be transported to any desired location. A surge suppressor is mounted within the housing. As in conventional power supplies, chargers and the like, the surge suppressor is adapted for connection to an external power supply, such as a standard 120 VAC electrical outlet, for example. Additionally, an AC-DC converter may be in electrical communication with the surge suppressor for converting AC electrical current provided by the external power supply into DC electrical current.

A plurality of electrical outlets are mounted to the upper portion of the housing and are in electrical communication with the surge suppressor. The plurality of electrical outlets may include at least two distinct types of outlets. For example, a plurality of universal serial bus type A (USB-A) outlets may be provided, and a plurality of USB type C (USB-C) outlets may be provided. At least one rechargeable battery is removably received within the internal compartment of the housing. The AC-DC converter, the at least one rechargeable battery and the plurality of electrical outlets may be electrically connected in parallel, such that the at least one rechargeable battery is selectively charged by a charging current delivered by the external power supply. Due to the connection in parallel, when the external power supply is connected, power is provided to the plurality of outlets by both the at least one rechargeable battery and the external power supply. However, when the mobile power and charging station is disconnected from the external power supply, power is provided to the plurality of outlets by the at least one rechargeable battery without interruption.

These and other features of the present disclosure will become readily apparent upon further review of the following specification and drawings.

### BRIEF DESCRIPTION OF THE DRAWINGS

FIG. 1 is a front perspective view of a mobile power and charging station.

FIG. 2 is a rear perspective view of the mobile power and charging station.

FIG. 3A is a partial side view of the mobile power and charging station.

FIG. 3B is a partial rear perspective view of the mobile power and charging station, showing an internal compartment thereof.

FIG. 4 is a partial perspective view of the mobile power and charging station, showing a base portion thereof.

FIG. 5 schematically illustrates electrical components of the mobile power and charging station.

Similar reference characters denote corresponding features consistently throughout the attached drawings.

### DETAILED DESCRIPTION OF THE PREFERRED EMBODIMENTS

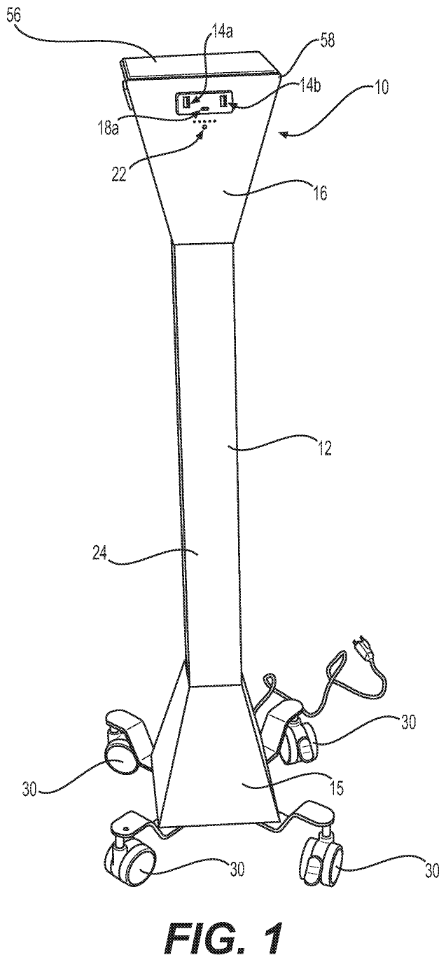

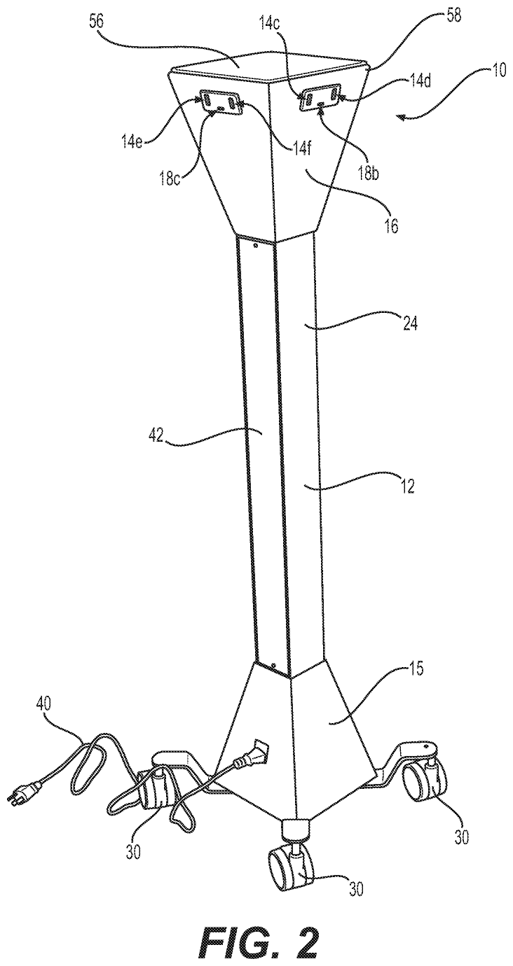

Referring now to FIGS. 1, 2, 3A and 3B, the mobile power and charging station 10 is a multiple outlet power and charging station with at least one on-board rechargeable battery for providing a transportable power supply for powering and charging mobile devices and the like. The mobile power and charging station 10 includes a housing 12 having an upper portion 16, a central portion 24 and a base portion 15. In FIGS. 1 and 2, the upper portion 16 of housing 12 is shown as having an inverted, truncated pyramid type contouring, central portion 24 is shown as being contoured as a parallelepiped, and base portion 15 is shown with a truncated pyramid type contouring. It should be understood that the overall shape and relative dimensions of housing 12 are shown for exemplary purposes only.

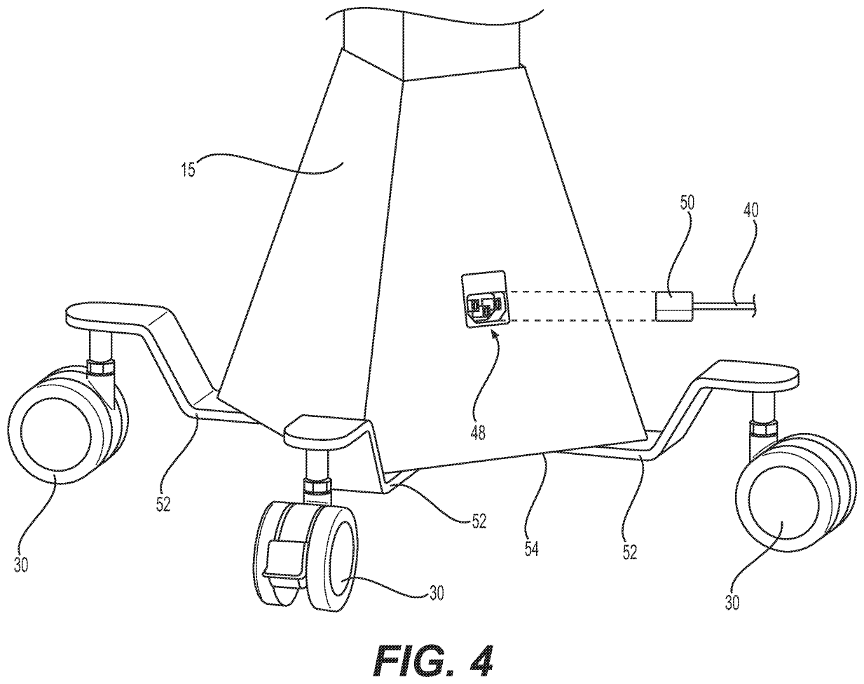

As best seen in FIG. 4, a plurality of wheels 30 are mounted on the base portion 15 of the housing 12, allowing the housing 12 to be transported to any desired location. In FIGS. 1, 2 and 4, four such wheels 30 are shown, each being pivotally attached to a corresponding leg 52 extending from a lower end 54 of base portion 15. It should be understood that any suitable number of wheels 30 may be used and, similarly, that any suitable type of legs 52 or supports for the plurality of wheels 30 may be used. Further, in the non-limiting example of FIGS. 1, 2 and 4, the wheels 30 are shown as being dual-wheel locking casters. It should be understood that any suitable type of wheels may be utilized. Similarly, it should be understood that the overall contouring and relative dimensions of legs 52 are shown for exemplary purposes only.

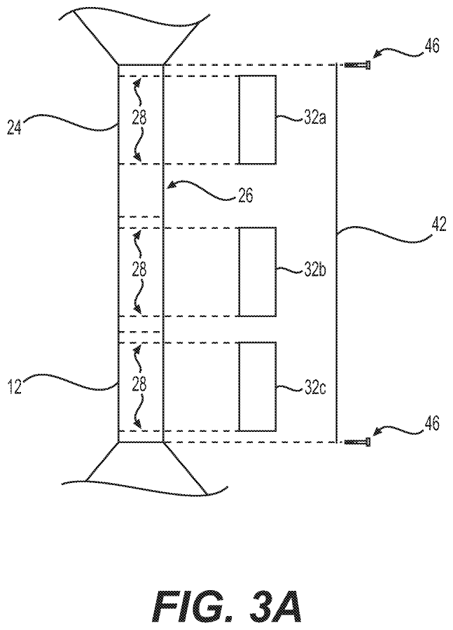

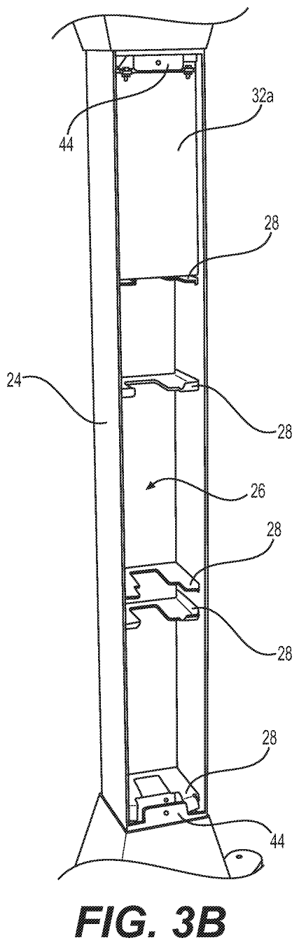

As best seen in FIGS. 3A and 3B, the central portion 24 may have an internal compartment 26 defined therein, although it should be understood that internal compartment 26 may be located in any suitable location with respect to housing 12. In FIG. 3A, three rechargeable batteries 32a, 32b, 32c are shown being installed within the internal compartment 26. It should be understood that in addition to a main rechargeable battery, such as rechargeable battery 32a, any desired number of auxiliary batteries may be added, and that the three-battery configuration of FIG. 3A is shown for exemplary purposes only. Additionally, as shown, a door 42 may be provided for releasably covering the internal compartment 26. In FIG. 3A, door 42 is shown as being releasably attached to central portion 24 by a pair of conventional screws 46, which engage brackets 44 (shown in FIG. 3B), however, it should be understood that door 42 may be releasably secured to central portion 24 of housing 12 by any suitable type of releasable attachment or locking mechanism.

As shown in FIG. 3B, the internal compartment 26 is provided with sets of internal support brackets 28 for stably supporting each rechargeable battery therein. For purposes of illustration and clarity, only the main rechargeable battery 32a is shown installed in internal compartment 26 in FIG. 3B. As will be described in greater detail below, batteries 32a, 32b, 32c are connected in parallel, thus any auxiliary batteries may be removed or installed without interruption of power or function. It should be understood that the overall configuration and relative dimensions of the rechargeable batteries 32a, 32b, 32c are shown for exemplary purposes only.

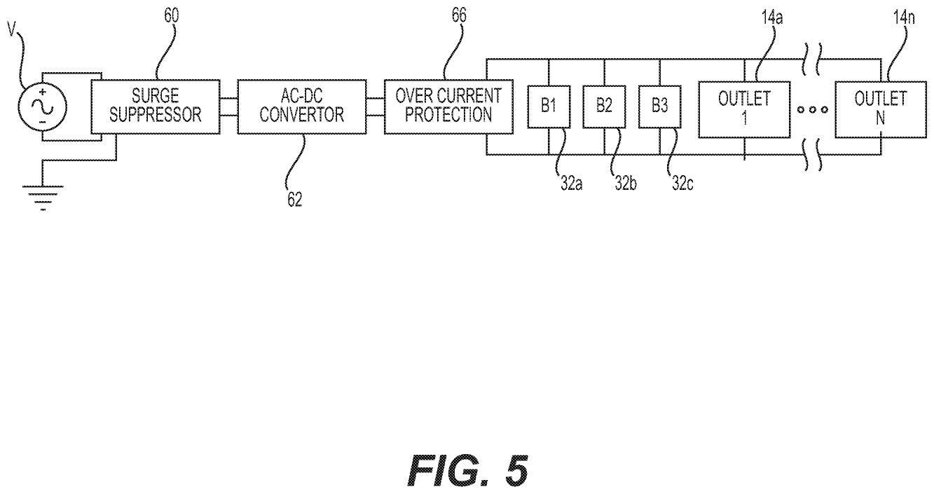

With further reference to FIG. 5, a surge suppressor 60 is mounted within the housing 12. As in conventional power supplies, chargers and the like, the surge suppressor 60 is adapted for connection to an external power supply V, such as a standard 120 VAC electrical outlet, for example. In FIG. 4, a conventional power cord 40, having a conventional head 50 for removable connection with a socket 48, is shown. It should be understood that the power cord 40 and socket 48 are shown for exemplary purposes only, and that any suitable type of power cord connection, for providing power from external power supply V, may be used. It should be further understood that the mobile power and charging station 10 may be used with any suitable type of external power source, such as, for example, a conventional 120 VAC power supply. Further, although the socket 48 is shown as being positioned on the base portion 15, it should be understood that the socket 48 for the power cord 40 may be located at any desired position on the housing 12. Additionally, it should be understood that although the power cord 40 is shown as being removable from the socket 48, a permanently fixed power cord may also be used.

A plurality of electrical outlets are mounted to the housing 12. In the non-limiting example shown in FIGS. 1 and 2, three sockets are provided on each face of upper portion 16. It should be understood that the electrical outlets may be mounted to the housing at any desired location. In the non-limiting example of FIGS. 1 and 2, the plurality of electrical outlets are shown as including at least two distinct types of outlets. For example, a plurality of universal serial bus type A (USB-A) outlets may be provided, and a plurality of USB type C (USB-C) outlets may be provided. In the non-limiting example of FIG. 1, a pair of USB-A outlets 14a, 14b are shown grouped with a USB-C outlet 18a on the front side of housing 12. In the non-limiting example of FIG. 2, a second pair of USB-A outlets 14c, 14d are shown grouped with a USB-C outlet 18b on one side of housing 12, and it should be understood that a similar grouping may be mounted on the opposing side of housing 12. Similarly, another pair of USB-A outlets 14e, 14f are shown grouped with a USB-C outlet 18c on the rear side of housing 12.

In the above non-limiting example, the plurality of outlets are shown grouped together, with each side of the upper portion 16 of the housing 12 having one USB-C outlet and a pair of USB-A outlets. It should be understood that any desired number, and any desired type or combination of types, of outlets may be provided at any desired location on the housing. For purposes of illustration and clarity, in the diagram of FIG. 5, N total outlets are shown labeled as outlets 14a, . . . , 14n.

As described above, at least one rechargeable battery is removably received within the internal compartment 26 of the central portion 24 of the housing 12. In the diagram of FIG. 5, for purposes of clarity and illustration only, a first battery (B1) 32a, a second battery (B2) 32b and a third battery (B3) 32c are shown, although it should be understood that any desired number of rechargeable batteries may be connected in parallel. As shown in FIG. 5, an AC-DC converter 62 may be in electrical communication with the surge suppressor 60 for converting AC electrical current provided by the external power supply V into DC electrical current. It should be understood that any suitable type of AC-DC converter may be utilized.

The AC-DC converter 62, the at least one rechargeable battery 32a, 32b, 32c and the plurality of electrical outlets 14a, . . . , 14n may be electrically connected in parallel, as shown, such that the at least one rechargeable battery 32a, 32b, 32c is selectively charged by a charging current delivered by the external power supply V. Due to the connection in parallel, when the external power supply V is connected, power is provided to the plurality of outlets 14a, . . . , 14n by both the at least one rechargeable battery 32a, 32b, 32c and the external power supply V. However, when the mobile power and charging station 10 is disconnected from the external power supply V, power is provided to the plurality of outlets 14a, . . . , 14n by the at least one rechargeable battery 32a, 32b, 32c without interruption.

Additionally, as is well known in the art, an over current protection circuit 66 is provided to prevent overloads, short circuits and ground faults. It should be understood that any suitable type of over current protection circuit may be utilized. It should be understood that the over current protection circuit 66 may be placed in electrical communication with rechargeable batteries 32a, 32b, 32c by any suitable type of battery connectors, which may be any suitable type of connectors, wires, cables, buses or leads.

Further, as shown in FIG. 1, a visual indicator 22 may also be mounted to the housing 12. Visual indicator 22 may be, for example, a light emitting diode (LED). The visual indicator 22 may provide a visual indication of recharging of the at least one rechargeable battery 32a, 32b, 32c. In FIG. 1, the visual indicator 22 is shown mounted on the upper portion 16 of the housing 12. It should be understood that the particular choice of indicator illustrated, as well as the placement of the visual indicator 22, are shown for exemplary purposes only.

Returning to FIGS. 1 and 2, an elastomeric layer 56, such as a rubber sheet or the like, is shown secured to an upper end 58 of the upper portion 16 of housing 12. The elastomeric layer 56 provides both cushioning and enhanced frictional engagement for one or more mobile devices which are connected to the electrical outlets. As indicated above, the overall shape, configuration and relative dimensions of the mobile power and charging station 10 are shown for exemplary purposes only. As a non-limiting example, the mobile power and charging station 10 may have a height of approximately 40 inches, a lateral width of approximately 17.5 inches, and a longitudinal width of approximately 17.5 inches.

It is to be understood that the mobile power and charging station is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

We claim:

1. A mobile power and charging station, comprising:
a housing having an upper portion, a central portion and a base portion, the housing having an internal compartment defined therein;
a plurality of wheels mounted on the base portion of the housing;
a surge suppressor mounted within the housing, the surge suppressor being adapted for connection to an external power supply;
a plurality of electrical outlets mounted to the upper portion of the housing and being in electrical communication with the surge suppressor; and
at least one rechargeable battery removably received within the internal compartment of the housing, the at least one rechargeable battery being in electrical communication with the surge suppressor and the plurality of electrical outlets, whereby the at least one rechargeable battery is selectively charged by a charging current delivered from the surge suppressor, and the at least one rechargeable battery selectively provides auxiliary power to the plurality of electrical outlets when power from the external power supply is interrupted.

2. The mobile power and charging station as recited in claim 1, further comprising a visual indicator indicative of a recharging state of the at least one rechargeable battery.

3. The mobile power and charging station as recited in claim 1, wherein the plurality of electrical outlets comprise at least two separate and distinct types of electrical outlets.

4. The mobile power and charging station as recited in claim 1, further comprising an AC-DC converter in electrical communication with the surge suppressor for converting AC electrical current provided by the external power supply into DC electrical current.

5. The mobile power and charging station as recited in claim 4, wherein the AC-DC converter, the at least one rechargeable battery and the plurality of electrical outlets are connected in parallel.

6. The mobile power and charging station as recited in claim 1, further comprising a door for releasably covering the internal compartment of the housing.

7. The mobile power and charging station as recited in claim 1, further comprising a plurality of legs secured to, and extend outwardly from, a lower end of the base portion of the housing.

8. The mobile power and charging station as recited in claim 7, wherein each said wheel is pivotally secured to a corresponding one of the plurality of legs.

9. The mobile power and charging station as recited in claim 1, further comprising an elastomeric layer secured to an upper end of the upper portion of the housing.

10. The mobile power and charging station as recited in claim 1, wherein the upper portion of the housing is contoured as an inverted, truncated pyramid.

11. The mobile power and charging station as recited in claim 10, wherein the base portion of the housing is contoured as a truncated pyramid.

12. The mobile power and charging station as recited in claim 11, wherein the central portion of the housing is contoured as a parallelepiped.

13. A mobile power and charging station, comprising:
a housing having an upper portion, a central portion and a base portion, the housing having an internal compartment defined therein;
a plurality of wheels mounted on the base portion of the housing;
a surge suppressor mounted within the housing, the surge suppressor being adapted for connection to an external power supply;
an AC-DC converter in electrical communication with the surge suppressor for converting AC electrical current provided by the external power supply into DC electrical current;
a plurality of electrical outlets mounted to the housing; and
at least one rechargeable battery removably received within the internal compartment of the housing, the AC-DC converter, the at least one rechargeable battery and the plurality of electrical outlets being electrically connected in parallel, whereby the at least one rechargeable battery is selectively charged by a charging current delivered by the external power supply.

14. The mobile power and charging station as recited in claim 13, further comprising a visual indicator indicative of a recharging state of the at least one rechargeable battery.

15. The mobile power and charging station as recited in claim 13, wherein the plurality of electrical outlets comprise at least two separate and distinct types of electrical outlets.

16. The mobile power and charging station as recited in claim 13, further comprising a door for releasably covering the internal compartment of the housing.

17. The mobile power and charging station as recited in claim 13, further comprising a plurality of legs secured to, and extend outwardly from, a lower end of the base portion of the housing.

18. The mobile power and charging station as recited in claim 17, wherein each said wheel is pivotally secured to a corresponding one of the plurality of legs.

19. The mobile power and charging station as recited in claim 13, further comprising an elastomeric layer secured to an upper end of the upper portion of the housing.

20. A mobile power and charging station, comprising:
a housing having an upper portion, a central portion and a base portion, the housing having an internal compartment defined therein;
a door for releasably covering the internal compartment of the housing;
a plurality of wheels mounted on the base portion of the housing;
a surge suppressor mounted within the housing, the surge suppressor being adapted for connection to an external power supply;
an AC-DC converter in electrical communication with the surge suppressor for converting AC electrical current provided by the external power supply into DC electrical current;
a plurality of electrical outlets mounted to the housing, wherein the plurality of electrical outlets comprise at least two separate and distinct types of electrical outlets; and
at least one rechargeable battery removably received within the internal compartment of the housing, the AC-DC converter, the at least one rechargeable battery and the plurality of electrical outlets being electrically connected in parallel, whereby the at least one rechargeable battery is selectively charged by a charging current delivered by the external power supply.
